(19) United States
(12) Patent Application Publication
(10) Pub. No.: US 2019/0354694 A1
(43) Pub. Date: Nov. 21, 2019

(54) VERIFICATION OF DATA CAPTURED BY A CONSUMER ELECTRONIC DEVICE

(71) Applicant: SERELAY LIMITED, London (GB)

(72) Inventor: Roy AZOULAY, London (GB)

(21) Appl. No.: 16/476,005

(22) PCT Filed: Jan. 3, 2018
(86) PCT No.: PCT/IB2018/050036

§ 371 Date: Jul. 3, 2019

Related U.S. Application Data
(60) Provisional application No. 62/442,530, filed on Jan. 5, 2017.

(51) Int. Cl. G06F 21/60; G06F 21/64; H04L 9/08; H04L 9/06; G06F 16/27; H04L 9/32

(52) U.S. Cl. CPC G06F 21/602; G06F 21/64; H04L 9/0861; H04L 2209/38; G06F 16/27; H04L 9/3247; H04L 9/3242; H04L 9/0637

(57) ABSTRACT

A system is provided for storing verifiable data captured by a capture device. The primary data may be for example a photograph or video and the capture device may be for example a mobile telephone. Metadata may include for example the time and location when the photograph was captured. The capture device calculates a cryptographic transformation of the primary data, and transmits it to a server device for storage. At a later time a purported photograph for example can be verified as a true and unaltered copy of primary data created on the capture device, by calculating a cryptographic transformation of the purported photograph and comparing the calculated transformation with the transformation previously stored on the server device.

The present invention relates to a system and method for verifying the integrity of data captured by a capture device. For example, data captured by a camera or video camera on a consumer electronic device such as a mobile telephone. The data captured may include primary data, for example a photograph or video recording, and metadata, for example specifying the time and place where the photograph or video recording was taken.

### BACKGROUND TO THE INVENTION

Consumer devices which capture data from their physical surroundings are now ubiquitous. For example, most modern mobile telephones include a camera for capturing both stills and video, and a microphone for capturing sound recordings, either as a sound channel to a video recording or a separate sound recording.

Special-purpose devices are also increasingly common, for example dashboard-mounted cameras designed to record the view out of a vehicle windscreen to provide evidence in case of an accident, and body-worn cameras used by police to evidence their interactions with the public.

Known devices often not only record primary data, for example photographs or video, but also record metadata relating to the capture. For example, when capturing a photograph, many devices will store the current time and date (from an internal clock in the device which may be synchronised in some way with a time server on a network), and coordinates of the physical location of the device when the photograph was captured (from a positioning system, for example a GPS or GLONASS receiver). It is also known to store an identifier for the device.

In most cases, this metadata is a convenient feature which is useful to a consumer so that he can view and share his photographs (for example) based on where and when they were taken, without the need to make notes and organise the captured pictures manually. However, in some cases verifying that the recorded metadata is correctly attributable to primary data which is unaltered is critical. For example, proving that a particular photograph is a direct and unaltered capture from a camera on a particular device, made at a particular time and in a particular geographical position, could be invaluable in a variety of circumstances—for example when relying on photographs to support an insurance claim.

News organisations often receive submitted photographs and videos from members of the public, but these organisations have to be careful to verify the authenticity of what they are being presented with—in particular that the photograph (for example) is a direct unaltered capture from a camera and that it was taken at the time and place claimed. In the past, even reputable news organisations have fallen victim to falsified submitted photographs and published then as genuine.

It is an object of the present invention to provide means by which the integrity of data captured by a consumer electronic device may be verified, in particular to verify that primary data is unaltered and truly corresponds to particular metadata.

### SUMMARY OF THE INVENTION

According to the present invention, there is provided a system for creating verifiable data, the system comprising:
a capture device, the capture device including at least one sensor for capturing primary data, and being adapted to provide at least one item of metadata relating to the captured primary data, and the capture device further including a processor;
a server device, the server device including data storage; and
a data transmission channel being provided for allowing data transfer between the capture device and the server device,

the capture device being adapted to carry out the steps of:
acquiring primary data from the sensor and storing the primary data;
calculating a cryptographic transformation of the primary data;
optionally calculating a cryptographic transformation of the at least one item of metadata;
transmitting the cryptographic transformation of the primary data, together with at least one of the at least one item of metadata and the cryptographic transformation of the at least one item of metadata,

and the server device being adapted to receive and store the cryptographic transformation of the primary data, together with at least one of the at least one item of metadata and the cryptographic transformation of the at least one item of metadata.

The sensor for capturing primary data may be, for example, a camera and/or a microphone. It is envisaged that many embodiments of the capture device will be a modern mobile telephone, for example running the Android operating system and including sensors in the form of a camera and a microphone. However, special-purpose embodiments, for example ‘dash cams’ are also envisaged. Furthermore, a mobile telephone might have external sensors, for example a high resolution camera, connected.

The data transmission channel may be provided by, for example, a mobile telephone network or WiFi network. It will be understood that the data transmission channel will usually include multiple components and in most embodiments will rely on at least some other network devices.

The simplest embodiment of a cryptographic transformation is a cryptographic hash. A cryptographic hash has the property that it is infeasible to produce forged primary data matching a given hash. This is the essential property required in the system of the invention. In some embodiments, the cryptographic transformation may be a MAC (Message Authentication Code) or a digital signature. These options have the additional property that the ability to generate the MAC is linked not only to possession of unaltered primary data but also to possession of a shared secret key. In the case of a digital signature, it is possession of the private part of an asymmetric key which is required. However, in both of these cases, it is the inability of an attacker to produce forged primary data matching a given digital signature or MAC which is critical. In the rest of the description, “cryptographic hash” or just “hash” is to be understood as any transformation having this property, including MACs and digital signatures.

Use of a MAC or digital signature provides an additional layer of assurance. The security of the system relies on the assumption that the hardware and software of the capture device has not been tampered with and works in the expected way. Checks for a ‘rooted’ device and unaltered software, as explained in more detail below, go some way to ensuring that this assumption is correct. However, embedding a secret key within the program code of software in the device, and using the secret key when generating a MAC or digital signature instead of a simple hash, helps to ensure that only unaltered software will be able to produce verifiable data in the system of the invention. The secret key can be stored in the compiled program code in a way which makes it very difficult to retrieve and use in the context of another program designed to masquerade as a capture device with unaltered software. In some embodiments, the secret key may be derived as a cryptographic digest of the compiled program code for the software.

Alternatively or additionally, a secret key could be used as part of a separate authentication protocol between the capture device and the server device, as well as or instead of using a secret key as part of generating the cryptographic transformation of the primary data.

In some embodiments, a secret key is simply used to reversibly encrypt a hash.

In some embodiments, the operating system on the capture device may have access to a key store or trust zone. The key store or trust zone may be a hardware feature of the device subject to specific security protections, which can be reliably and safely used to store secret keys and/or perform secure cryptographic operations. The key store/trust zone may be used to generate and/or store secret keys, reducing the dependence on a key hard-coded within the application.

Secret keys may be used as part of a cryptographic transformation that involves a secret key, for example a MAC or digital signature. Alternatively or additionally, a secret key may be used to temporarily and reversibly encrypt cryptographic transformations which are stored temporarily on the device, pending transmission to the server, for example in the case of non-availability of the data transmission channel.

The cryptographic hash of the primary data allows computationally easy verification at a later stage that an alleged copy of the primary data is a true unaltered copy of that data. The cryptographic properties of the hash function make it extremely difficult however to produce a different or altered photograph (for example) which will correspond to the same hash value.

The additional use of a secret key also proves that the cryptographic transformation is produced by a program in possession of the secret key. With appropriate controls on the secret key, this may provide a reasonable level of assurance that the program in possession of the secret key must be an unaltered, genuine program which acts strictly in accordance with the method of the invention.

In a simple case, a cryptographic hash of the whole of the primary data may be calculated in a single step. This is practical for example for calculating the hash of a photograph. For continuous data recorded over a period of time, for example a video recording or sound recording, it may be preferable to calculate cryptographic hashes of blocks of data, while data is still being captured. For example, a hash of the first five seconds of video could be calculated although recording may continue. If the recording is still ongoing after ten seconds, then a hash of the second block (from five seconds in to ten seconds in) can be calculated, and so on. Once the recording has finished and a hash of the last block has been calculated, a single hash over all previous hashes can be calculated. This has the advantage firstly that hashes of relatively small blocks of data can be calculated on an ongoing basis, so there is not a single and potentially slow (due to processor time and also storage I/O) hash of a large amount of data required at the end of the capture, and secondly that hashing of blocks on an ongoing basis during capture provides some assurance that the early parts of the recording have not been somehow altered during capture of the later parts.

Where “block hashes” are calculated as described above, a flag may be attached to the transmitted data to record the fact that block hashing was used, and possibly providing other parameters to allow the hash to be verified, for example the length of the block.

Simple examples of items of metadata which may be provided by the capturing device include an identifier for the particular capturing device, the current date and time, and the current geographical location.

Where the server device is operated by a trusted entity, the data stored in the storage means on the server device can be used to provide assurance that a particular photograph (or other primary data) was taken at a particular time, in a particular location, and on a particular device.

Preferably, the primary data is not transferred to the server device. The capture device may include data storage and the primary data may be stored on the capture device. This has two advantages. Firstly, the primary data file(s) may be large and may be costly and/or slow to transfer over the data transmission channel and store. Secondly, users may be uncomfortable for privacy reasons with transmitting all captured data to a third party server. Transmitting only a cryptographic hash of the primary data together with either the metadata or a hash of the metadata obviates this problem. Users may choose to allow transmission of this data for all photographs, videos or other captures from their device, but the data transmitted is meaningless on its own and does not represent a privacy concern. A majority of the transmitted data may never be used, if there is no particular dispute or need to prove the provenance of it. However, if it becomes necessary even in an isolated case to provide further assurance as to the date and time (for example) when a particular photograph was captured, this will be possible.

Preferably, a cryptographic hash of the metadata is calculated, and the hash of the metadata is transmitted to the server device. In some embodiments, the raw metadata may be transmitted as well as or instead of the hash, depending on the particular requirements of the system. Transmitting only the cryptographic hash of the metadata further reduces privacy concerns, because the user is not sending to the third party information for example that he was in particular places at particular times. However, transmitting the raw metadata as well not only allows purported metadata to be verified as truly corresponding to particular primary data, but in case there is a mismatch, the true metadata may be recovered from the storage on the server device.

Preferably, the capture device also calculates a hash of the combination of the primary data and the metadata. The primary data and metadata could be combined in any way as long as it is done consistently. In particular the “combination” hash could be a hash of a combination of the hash of the primary data and the metadata, or a hash of a combination of the hash of the primary data and a hash of the metadata. This combination hash binds the content to the metadata, which can be particularly valuable in a scenario where for some reason there is a delay between capturing the primary data and transmitting the hash(es) and/or metadata to a server device. Such a delay is undesirable, but may be caused, for example, when the data transmission channel is temporarily unavailable because the capturing device is out of range.

By transmitting the hash of the primary data together with the metadata and/or a hash of the metadata as quickly as possible, the opportunity for the data to be tampered with is reduced and the confidence in the integrity of the primary data when compared against the stored data is improved. For that reason it is desirable for the server device to store the time and date of receipt alongside the received data. Also, the metadata transmitted by the primary device may include not only the time of capture, but the time of transmission. In normal circumstances all of these times ought to be very close together. A time of receipt not substantially matching the time of transmission may indicate an inaccurate clock on the capturing device. A time of transmission and receipt not substantially matching the time of capture may indicate that the data transmission channel was temporarily unavailable. This may be innocent in most circumstances but nevertheless the confidence in the integrity of the data may be reduced.

In some embodiments, the calculated hashes may be retained on the capture device, but there is no particular requirement to do so. After transmission, the calculated hashes may be deleted from the capture device. Only the primary data, and optionally the metadata, is usually stored on the capture device, and the primary data/metadata could be transferred to another device where required.

The system of the invention calculates the hash of primary data at the point of capture, i.e. on the same device which is doing the capturing, and immediately when the capture is made. This provides assurance that the primary data really is unaltered data which has come from the sensor, and is not for example a previously captured photograph which has been transferred to the device. In certain embodiments, the capture device may be a mobile telephone running for example the Android® operating system. In this case, a check will be carried out to ensure that the device has not been ‘rooted’. Assuming that the device has not been ‘rooted’, the same program which calculates the cryptographic hashes and causes the results to be transmitted may be assured that the data it is acquiring really does come directly from the sensor.

The check for a ‘rooted’ device may involve at least one of a local check and a third-party attestation. Most preferably, both of these checks are performed. The local check may check for certain traits of the operating system which are expected to be in place for a normally-configured device. Various libraries are available for the Android operating system in particular which can facilitate this. An example of a third-party attestation, again in relation to Android, is the Google SafetyNet Attestation API. A device which is attested to be a genuine, certified device with a known “safe” configuration can be treated as reliable in the sense that what the app believes to be a sensor for capturing primary data (for example a camera), really is a camera and is not being emulated. The data coming from the camera therefore really is an image of the immediate surroundings of the device.

The communication protocol between the capture device and the server device also ideally includes some form of check that the server is communicating with a particular software application on the capture device, and that application has not been tampered with. A known digital signature process is used to facilitate this, in particular the Android operating system provides an “Instance ID”, which can be retrieved during runtime of the application, and used with a third-party service run by Google to confirm that the app running on the device is an unaltered and specific copy of a previously approved and digitally-signed application.

Preferably, the program is arranged to have exclusive access to a particular area of storage on the capture device. Exclusive access may be arranged via features of the operating system on the capture device. The area of exclusive access may be used for storing calculated hash values temporarily prior to transmission to the server device. After transmission, the calculated hashes may be moved to shared storage or alternatively just deleted. The area of exclusive access may also be used in some embodiments to store private keys or shared secret keys, where the cryptographic transformation is for example a MAC or a digital signature, requiring use of a key.

Preferably, the metadata includes a geographical location. In many embodiments, this may come from a location module, for example a GPS, GLONASS, or other positioning system receiver. Preferably, the metadata further includes other environmental data, for example, the identity of cell towers which can be ‘seen’ by the mobile telephone transceiver in the capture device. In this context, the ‘timing advance’ parameter of the GSM system can be used to estimate the distance to particular cell towers and this may be part of the metadata. The identities and characteristics of WiFi networks may also form part of the metadata. Depending on the hardware present on a particular device, it may also be possible to include, for example, azimuth, elevation, and barometric pressure, or some combination of those. Environmental data available to the capture device might include for example data from a magnetometer, a light sensor, an accelerometer, a gyroscope, a gravity sensor, an orientation sensor, a barometer, and a temperature sensor. By storing, for example, temperature and light level from sensors, further corroborating data is provided to establish the time and place.

Increasing the amount of metadata stored can allow for further confidence as to the provenance of primary data verified using the system. As an example, one attack on the system may be to spoof GPS transmissions in the vicinity of a capture device. This would cause the GPS receiver on the capture device to report an inaccurate location. By storing as much environmental data as possible, the alleged position can be checked against reference data, for example reference data collected at a similar time and a similar alleged place by other users of the system with their own capture devices. Inconsistencies in the radio networks seen locally might indicate a possible attempt to tamper with the position information, and a lower level of confidence being given to particular primary data and its associated metadata.

The server device may store data in a known type of database, for example a relational database.

In some cases the server device may be provided by a distributed network of computers. In some embodiments, the server device in the form of a distributed network of computers may store data in a sequential distributed database in the form of a blockchain. In some embodiments therefore, it is possible that multiple devices (e.g. mobile telephones) all play the role of both capture devices and server devices, and it may be the case that there is no device which is a server device and not also a capture device, and/or there may be no device which is a capture device and not also a server device. However, it is critical to the operation of the system that for a particular capture, there is at least one device other than the device doing the capturing which can play the role of the server device.

When required, alleged primary data said to correspond to particular alleged metadata may be verified by calculating a cryptographic hash value of the alleged primary data, querying the data storage means on the server device, and comparing the alleged metadata to metadata stored on the server device. Where the server device only stores a hash of the metadata, a hash of the alleged metadata will be calculated for comparison. If a record corresponding to the hash of the alleged primary data is present in the data storage means of the server device, and the stored metadata or metadata hash matches the alleged metadata, then the alleged primary data may be verified. This verification may be subject in certain circumstances to certain qualifications or caveats, for example confidence may be reduced if no cell towers or WiFi networks were ‘visible’, or environmental data does not match expected reference values for the location, or if the time of capture does not substantially correspond to the time of receipt by the server device.

The verification process may take place on different devices in different embodiments. For example, the verification process may take place on the server device, or on the capture device, or on a third party device. As long as the device doing the verification can reliably access the trusted data stored on the server device, the verification process can be performed.

According to another aspect of the invention, there is provided a system for creating verifiable data, the system comprising:
a capture device, the capture device including at least one sensor for capturing primary data, and being adapted to provide at least one item of metadata relating to the captured primary data, and the capture device further including a processor;
a server device, the server device including data storage; and
a data transmission channel being provided for allowing data transfer between the capture device and the server device,

the capture device being provided with a computer program which when executed on the processor causes the capture device to carry out the steps of:
communicating with the server device using a security protocol to establish a device key on the capture device which is trusted by the server device;
acquiring primary data from the sensor and storing the primary data;
calculating a MAC or digital signature of a combination of the primary data and the metadata, using the device key;
embedding the MAC or digital signature of the combination of the primary data and the metadata into the primary data, and storing the primary data with embedded MAC or digital signature.

In this aspect of the invention, no cryptographic transformations of either primary data or metadata need to be stored on the server. The role of the server is to provide a repository of trusted devices and associated keys which may be used by capture devices to create trusted MACs (message authentication codes) or digital signatures. Different embodiments may achieve this in different ways. However, the starting point is for the server to trust that the capture device is running unmodified approved software which performs the steps of the method. As described in relation to the first aspect, this may be done by various means including using third party attestation services, for example the Google SafetyNet Attestation API. When the server has established that it can trust the device, a secret key can be generated and shared between the capture device and the server (in the case where a MAC is used) or an asymmetric key pair can be generated, with the capture device keeping the private part of the key pair and the server device storing the public part of the key pair (in the case where a digital signature is used). It is generally immaterial whether the key is actually generated on the server device or on the capture device, but it may be preferable in some embodiments to generate an asymmetric key pair on the capture device, since then only the public part of the key pair has to be transmitted.

In some embodiments, unencrypted metadata might also be embedded into the primary data file. The combination of primary data and metadata which is digitally signed may take various forms. In one example, the primary data is hashed and the metadata is hashed, and then a combination of the two hashes is digitally signed. In some embodiments a digital signature just relating to the primary data may be stored, and/or a digital signature just relating to the metadata may be stored. However, it is the digital signature of the combination of the two which allows verification that not only is the primary data genuine unaltered primary data, and the metadata is genuine unaltered metadata, but the metadata does relate to the particular primary data.

To verify primary data and metadata created by the system, the purported primary data with embedded signature or MAC can be uploaded to the server, which will verify that the purported primary data and purported metadata matches the digital signature or MAC which has been embedded. Furthermore, the server can verify using stored shared secret keys or stored public keys that the signature was produced by a trusted device.

In some embodiments, where a public-private key pair is used and therefore the public key does not need to be stored securely, the checking may take place on a third party device rather than on the server device, with the server simply providing the public key to facilitate the checking. In all embodiments, the server's essential role is in initially checking whether a capture device can be trusted, and then maintaining an authoritative store of keys relating to trusted devices.

### BRIEF DESCRIPTION OF THE DRAWINGS

For a better understanding of the present invention and to show more clearly how it may be carried into effect, preferred embodiments will now be described with reference to the attached drawings, in which:

FIG. 1 is a diagrammatic view of a capture device which is part of the invention;

FIG. 2 is a flow diagram illustrating part of a method of creating verifiable data on a capture device according to the invention;

FIG. 3 is a flow diagram illustrating part of a method of creating verifiable data on a capture device whereby software on the capture device has exclusive access to a subset of the data storage on the capture device;

FIG. 4 is a flow diagram illustrating a method of retrieving and verifying the integrity of data stored using the method of FIG. 2 and FIG. 3;

FIG. 5 is a flow diagram illustrating part of a method of creating verifiable data on a capture device, whereby a secret key is used;

FIG. 6 is a flow diagram illustrating a method of retrieving and verifying the integrity of data stored using the method of FIG. 5;

FIG. 7 is a diagrammatic view of a capture device, a communication network and a server device;

FIG. 8 is a flow diagram illustrating part of a method of creating verifiable data according to the invention;

FIG. 9 is a flow diagram illustrating a method of retrieving and verifying the integrity of data stored using the method of FIG. 8 in which the final step of the verification process is executed on the capture device;

FIG. 10 is a flow diagram illustrating a method of retrieving and verifying the integrity of data stored using the method of FIG. 8 in which the final step of the verification process is executed on the server device;

FIG. 11 is a diagrammatic view of a plurality of capture devices, a communication network and a database;

FIG. 12 is a flow diagram illustrating a method of populating a database with verifiable data captured on a plurality of capture devices;

FIG. 13 is a flow diagram illustrating a method of populating a database with verifiable data captured on a plurality of capture devices in case the database is a sequential distributed database in the form of a blockchain;

FIG. 14 is a diagrammatic view of a capture device, a communication network, a database, and a third party device; and

FIG. 15 is a flow diagram illustrating a method for an independent third party device to verify the integrity of data captured by a capture device.

### DESCRIPTION OF A PREFERRED EMBODIMENT

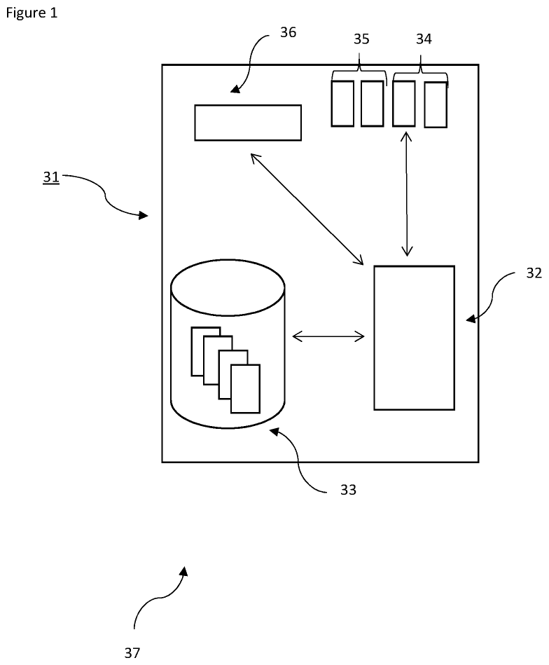

FIG. 1 shows a schematic of a capture device 31 for use as part of a system 37 according to the invention. The capture device includes data storage 33, a plurality of sensors and hardware components 34, 35, a key store 36, and a processor 32. The sensors may include for example a camera and a microphone. The further hardware components may include for example a GPS receiver and a mobile telephone transceiver. In many embodiments, the capture device is a mobile telephone running for example the Android operating system. However the capture device may take any form provided that the essential components are present.

The capture device 31 is loaded with a computer program which when executed on the processor 32 causes the capture device to acquire primary data from at least one of the plurality of sensors 34, for example image(s) may be acquired from a camera and/or audio may be acquired from a microphone. The computer program further causes metadata to be acquired, possibly from one or more of the hardware components 35. For example, position data may be acquired from a GPS receiver and/or cell tower data may be acquired from a mobile telephone transceiver. The computer program further causes a cryptographic transformation of the primary data to be calculated, and finally causes transmission of the cryptographic transformation of the primary data, together with the metadata, to a server device (not shown in FIG. 1). Between calculation and transmission of the cryptographic transformation, the cryptographic transformations may be stored preferably in an area of the data storage 33 which is made available exclusively by the operating system of the device to the computer program.

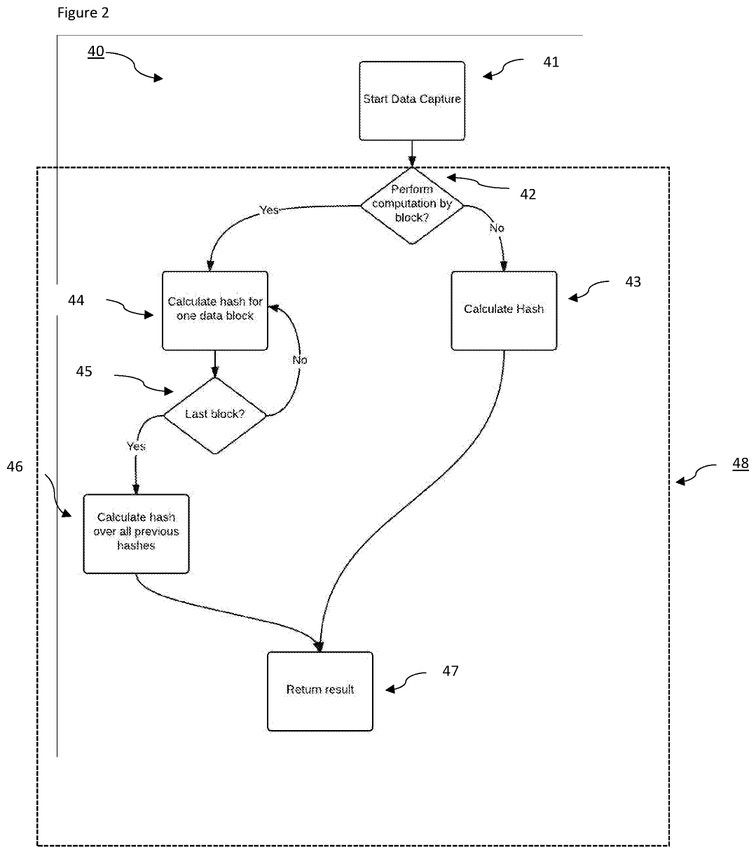

The capture device 31 can be used to capture primary data of a substantially fixed length, for example a single still photograph, or can be used to capture primary data which is of indeterminate length at the point the capture is begun, for example a video or sound recording. FIG. 2 at 40 illustrates how these different types of data are captured and made verifiable. At step 41 the computer program initiates data capture from at least one sensor (34). At step 42 an assessment is made as to whether to calculate the cryptographic transformation by block or by a single operation. The assessment is based on whether the capture being made is of substantially fixed length, for example where the capture is a single still photograph, or of indeterminate length, for example a video or sound recording. It will be understood that “substantially fixed length” does not imply that every still photograph captured will be exactly the same size, because the exact size of the data captured will in most cases depend on the characteristics of the capture and how they are compressed, for example in the common JPEG format. However a still photograph is captured in a short period of time by the sensor (camera).

If the capture being made is of a substantially fixed length then the cryptographic transformation will be calculated in a single operation, and the next step is step 43. If the capture being made is of indeterminate length then the transformation will be calculated as a block operation, and the next step is step 44. In the case of the single operation, the cryptographic transformation is calculated, and the result is returned and temporarily stored at step 47 ready for transmission to the server device. In the case of a block operation, a transformation is calculated of a first block of data in step 44, and then in step 45 the program tests whether the sensor is supplying more data. If so, then the process returns to step 44 to calculate a transformation of the next block of data. Each calculated transformation is temporarily stored, preferably in an area of data storage to which the computer program has exclusive access. When the process reaches step 45 and determines that there is no further data, the process moves to step 46 where a hash (or other transformation) is calculated over a combination of all previous hashes. At that point the temporarily stored individual hashes of each block can be deleted. The hash of hashes is stored at step 47 ready for transmission to the server device, in an area of data storage to which the computer program has exclusive access. In some embodiments a flag may be attached to the hash stored ready for transmission to indicate whether it was calculated by block or by single operation. Further information may also be attached, for example the length of the block if it is calculated by block.

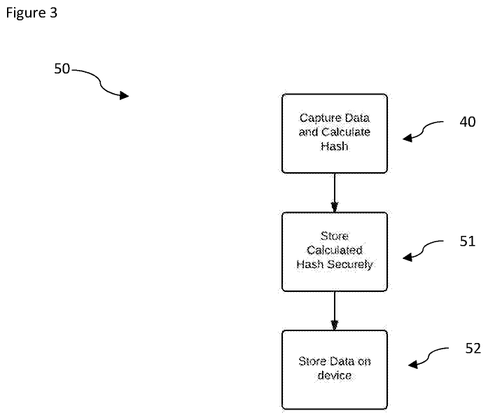

FIG. 3 illustrates at a high level the capture process 50 carried out on the capture device. The first step in FIG. 3, step 40, may be the steps set out in more detail in FIG. 2. This results in primary data and a corresponding hash. At step 51 the hash is stored securely. Secure storage may mean storage in a part of the data storage on the device to which the relevant program has exclusive access. Such storage may be temporary until such time as the capture device is able to transmit the hash to the server device, which is preferably as soon as possible. Finally, in step 52 the primary data is stored on the device. The primary data is not necessarily stored in an area of storage to which the relevant program has exclusive access. It is envisaged that in many embodiments the primary data may be stored in an area of storage having shared access so that the primary data can be accessed by other applications and potentially shared with others. The primary data could even be altered, but such alteration will be detectable in the sense that the system will no longer verify that altered data as the raw primary data captured.

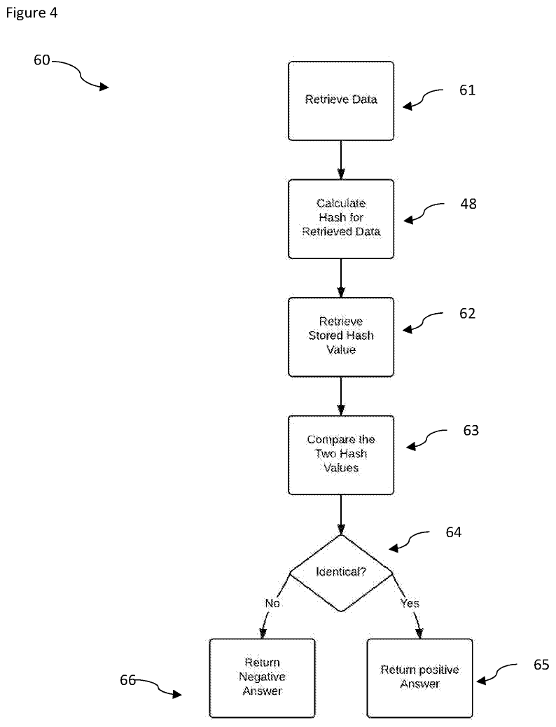

FIG. 4 illustrates the process 60 carried out when purported primary data previously captured by the system is to be verified. This process could be carried out on a capture device, or a server device, or on any other device capable of communicating with the server device and having access to the purported primary data. In step 61, the purported primary data is loaded. In step 48, a hash is calculated for the purported primary data. Note that step 48 is shown in more detail in FIG. 2 as a subset of process 40. In sub-step 42, the decision as to whether to perform the computation by block may be made based on information retrieved from the server, or alternatively it may be readily apparent from the nature of the primary data—for example in some embodiments a still photograph will always be transformed in a single step and a video will always be transformed block-by-block.

Once the hash of the purported primary data has been calculated in step 48, the stored hash value is retrieved from the server device in step 62. The calculated and retrieved hash values are then compared in step 63 and in step 64 a decision is made based on the outcome of the comparison. If the hashes are identical then a positive answer is returned in step 65, indicating that the purported primary data is indeed unaltered primary data originally captured by a capture device. If the hashes are not identical then a negative answer is returned in step 66, indicating that the purported primary data cannot be relied upon as unaltered primary data originally captured by a capture device.

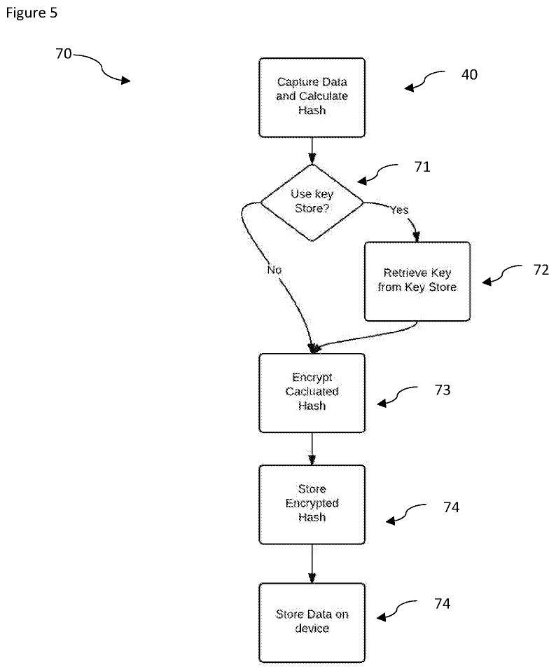

FIG. 5 shows a further process 70 which in some embodiments is carried out on the capture device to encrypt the hash. Note that the process 70 in FIG. 5 is just one example of a cryptographic transformation which includes a secret key. The process 70 includes calculating a hash and then encrypting a hash. However other transformations such as message authentication codes or digital signatures may be used which have the properties of a hash and also prove access to a secret key.

In process 70, first the data is captured and a hash calculated according to process 40 shown in more detail in FIG. 2. Then, at step 71 a decision is made as to whether to use a key store (36). Some capturing devices may include a key store and some may not, so the software is primarily checking to see if a key store is provided by the operating system. If a key store is available, it can be used to access a secret key at step 72. If no key store is available then the fallback position may be to use a secret key embedded in the compiled object code of the program. At step 73 the hash is encrypted using the secret key and at step 74 the encrypted hash is securely stored, and preferably sent to the server device as soon as possible. At step 74 the primary data is stored on the capture device, and this may be in a shared area of storage which is accessible to other applications.

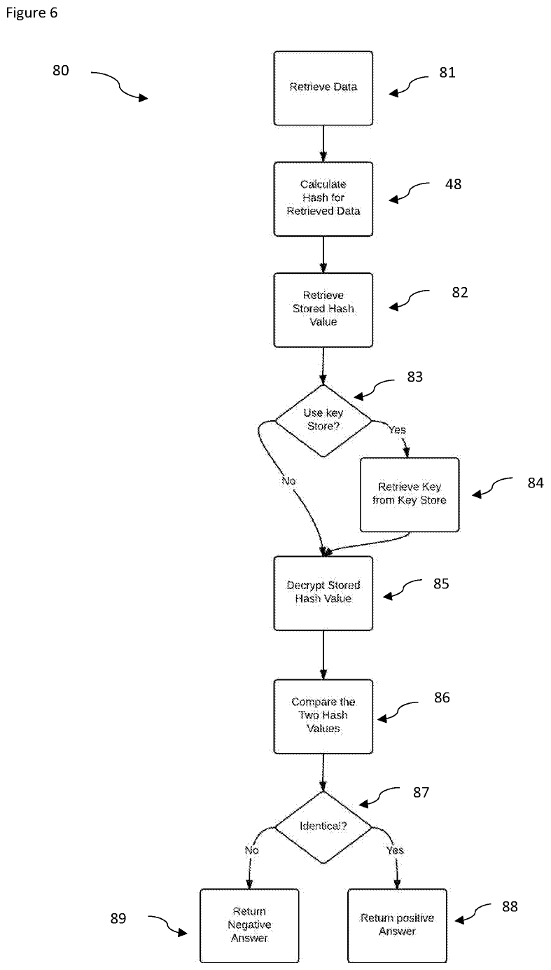

FIG. 6 shows process 80 for verifying the integrity of data stored according to the method 70 of FIG. 5. Process 80 is in most respects similar to process 60 of FIG. 4, except that process 80 includes steps 83, 84, 85 which obtain a secret key and decrypt the stored hash before a comparison is made. The decision at step 83 as to whether the key store is used is generally based on whether or not a flag is set in the data stored by the server device indicating that the key store was used on generation of the verifiable data in process 70.

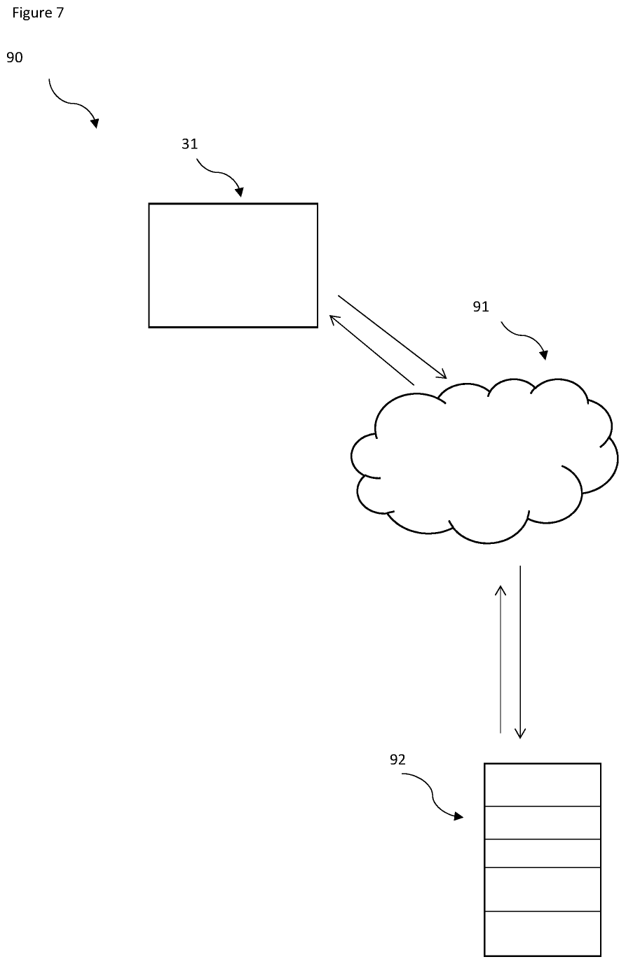

FIG. 7 shows in outline a system 90 embodying the invention. The system includes a capture device 31, a communication network 91 and a server device 92. Preferably, the capture device 31 is a mobile telephone and the system may include multiple capture devices all in communication with the server. The communication network 91 may include various components, and may include wireless parts (for example a mobile telephone data network or a WiFi network). The server device may be a single server or a plurality of devices providing the functions of the server device in a distributed fashion. In particular capture devices owned and controlled by other users of the system may in some embodiments perform the functions of the server device.

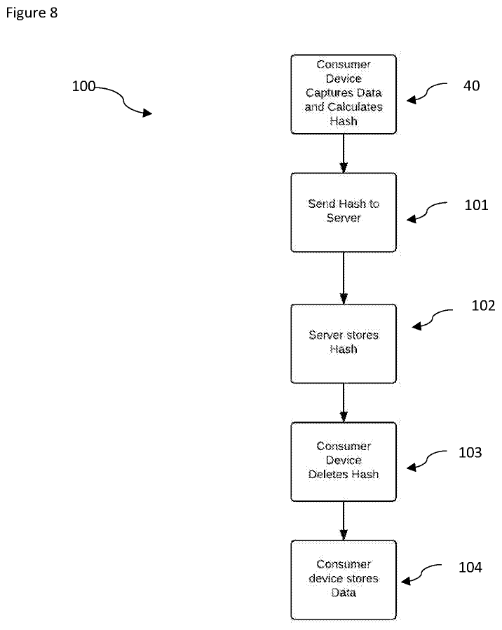

FIG. 8 shows a flow chart of a process 100 carried out by a server device (92). At step 40 a capture device captures data, and calculates and transmits a hash. More detail of this step is illustrated in FIG. 2, but for the purposes of server process 100, a hash is received from a capture device at step 101. The server stores the hash at step 102, alongside either metadata or a hash of the metadata which is also received from the capture device. The server might alternatively or additionally store a combination hash, which might be a hash of a combination of primary data and metadata, or a combination of a hash of primary data and a hash of metadata. The capture device then deletes the hash at step 103, since there is no further use in storing the hash on the capture device. Preferably, the capture device deletes the hash at step 103 in response to an acknowledgement from the server that the hash has been successfully stored. At step 104, the capture device stores primary data, which may be in a non-secure storage area in the sense that the primary data may be shared with other applications.

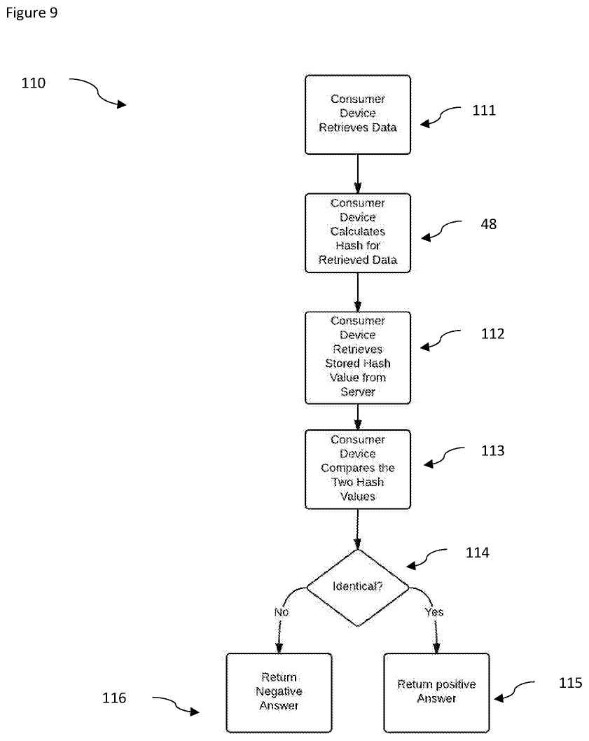

FIG. 9 shows a process 110 for verifying data stored by the process 100 of FIG. 8. Process 110 is in many respects similar to process 60 of FIG. 4, but process 110 is carried out on a device which is also a capture device. At step 111 the device retrieves data purported to be unaltered primary data. The retrieval could be of primary data originally stored by the capture device running the process, or it could be primary data originally stored by a different capture device. At step 111 the data retrieved is unverified and untrusted, and could have been retrieved from an insecure storage location, i.e. a storage location to which other programs have access. At step 48 (shown in more detail in FIG. 2) a hash of the retrieved data is calculated. At step 112 a stored hash is retrieved from a trusted server device. Note that the server is trusted either because it is controlled by a trusted entity, or because it includes inherent safeguards which preclude tampering with the data stored on the server, for example because the server device is a collection of multiple distributed devices storing data on a blockchain. At step 113 and 114 the calculated hash is compared to the hash retrieved from the trusted server, and if the hashes are identical then a positive answer is returned at step 115, indicating that the purported data is in fact unaltered data originally captured by a capture device, or alternatively if the hashes are not identical then a negative answer is returned at step 116, indicating that the purported data may not be unaltered data originally captured by a capture device.

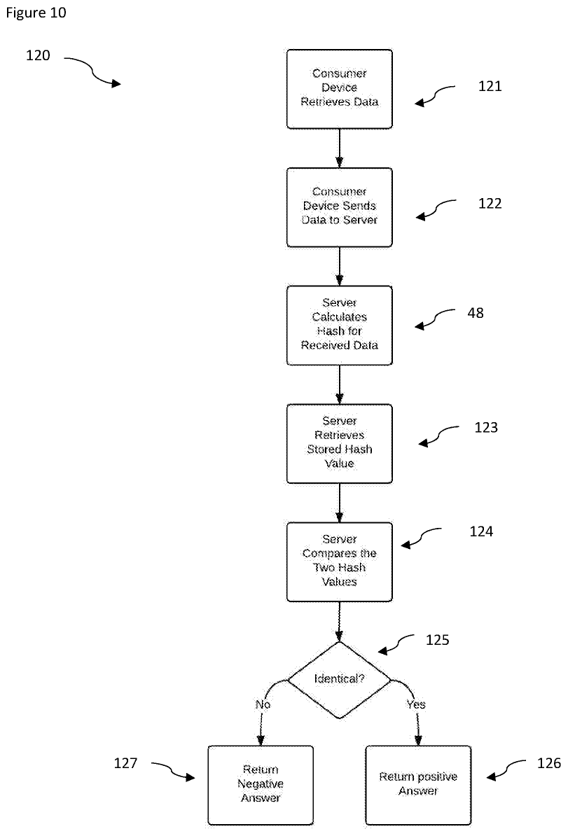

FIG. 10 shows a process 120 which is very similar to the process 110 of FIG. 9, but although a device which may also be a capture device retrieves data from an untrusted store in step 121, that data is then sent to the server device in step 122. Steps 48, 123 (corresponding to step 113), and 124 (corresponding to step 114) are then carried out on the server. When a result is returned in step 126 or step 127, preferably the result is transmitted from the server to the device which retrieved the data in step 121.

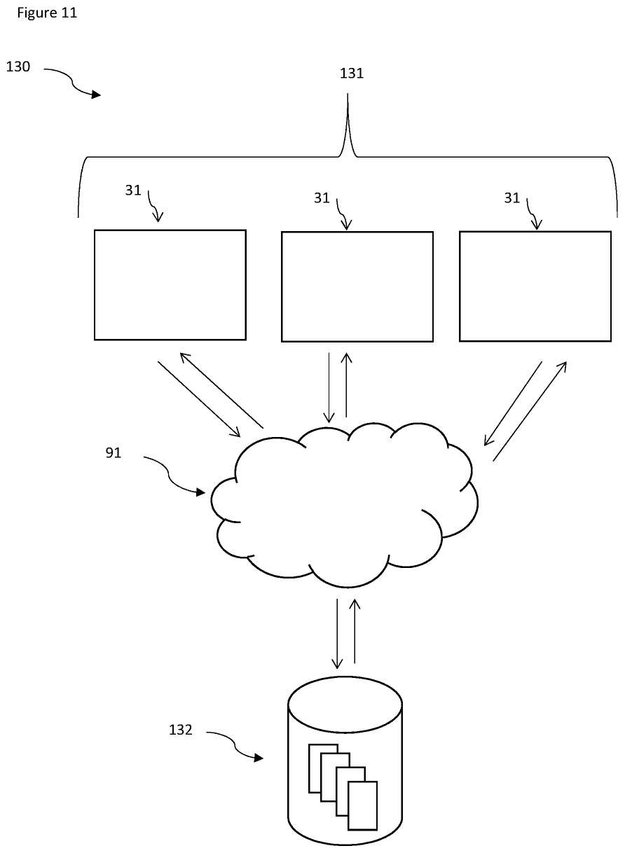

FIG. 11 shows an embodiment of a system 130 for creating verifiable data, the system including a plurality of capture devices 131. Each device 31 has the features shown in more detail in FIG. 1. All of the capture devices 31 are connected to the same network 91 and all can communicate with the server device 132. Note that the “same network” 91 may in fact be a complex internetwork including a variety of different parts, but it is the same network in the sense that all capture devices 131 can access the server 132.

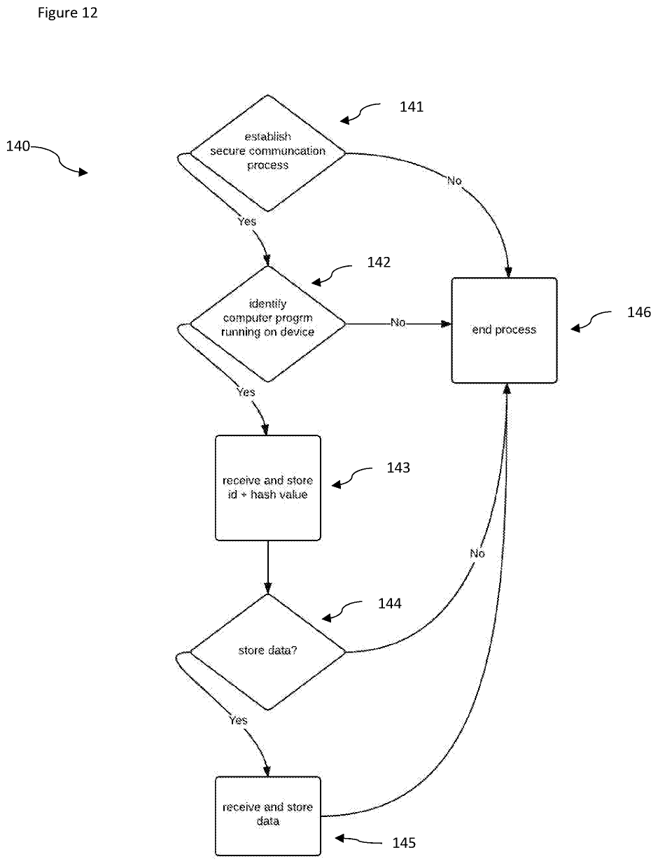

FIG. 12 shows a process 140 for populating a database 132 on a server device with data to support verification of primary data captured on capture devices 131. At step 141 a secure connection is established between a capture device 31 which has recently captured or is in the process of capturing primary data. At step 142 a check is made to ensure that the program running on the device is an unaltered copy of a trusted program. This may involve querying a third party service to verify for example a digital signature provided by the program. As an example, a device which is running a safe, certified and unaltered version of the Android operating system can be verified using the Google SafetyNet Attestation API. Such a trusted operating system in turn provides features to allow verification that the application program communicating with the server device is an unaltered copy of a trusted and digitally signed program. If this check fails then the process ends with failure at step 146—verifiable data has not been created. However, if this check succeeds then the process continues to step 143, where a hash of primary data together with either metadata or a hash of metadata is received from the capture device and stored. Preferably, the server also stores a unique identifier for the capture device. The unique identifier may be obtained and validated as correct during the identification step 142. The process then continues to step 144 where a decision is made as to whether to receive and store primary data. Whether this occurs is primarily up to the capture device and the choices which the user has made. By providing the unaltered primary data at this stage, possibly an extra level of confidence can be attached to the integrity of that data, but alternatively due to privacy concerns the user may prefer not to send primary data each time to the third party server, in which case the presence of the hash at an early stage should provide at least a good level of confidence. In some cases, the user may wish the primary data to be stored by the server device simply to act as a cloud storage/backup service. At step 145, the primary data is stored if this is required. The process then ends with success.

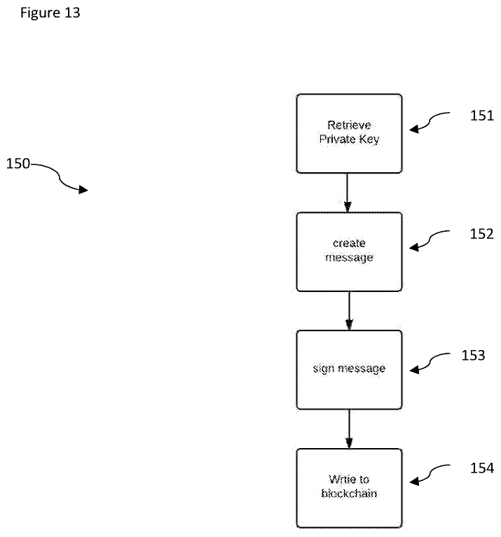

FIG. 13 sets out a process which is carried out by a capture device in the case that the server device is a distributed network of devices and the data storage of the server device is a blockchain. At step 151 the program running on the capture device 31 retrieves the private key of an asymmetric key pair. The private key is stored in such a way that there is a reasonable guarantee that the relevant program on the specific capture device is the only program which can access the private key. At step 152 the capture device creates a message including an id number uniquely identifying the device and/or the primary data captured by the device, and a hash of the data, and either relevant metadata or a hash of metadata. At step 153 the capture device digitally signs the message using the private key. At 154 the capture device uses the data transmission channel to write the signed message to the blockchain.

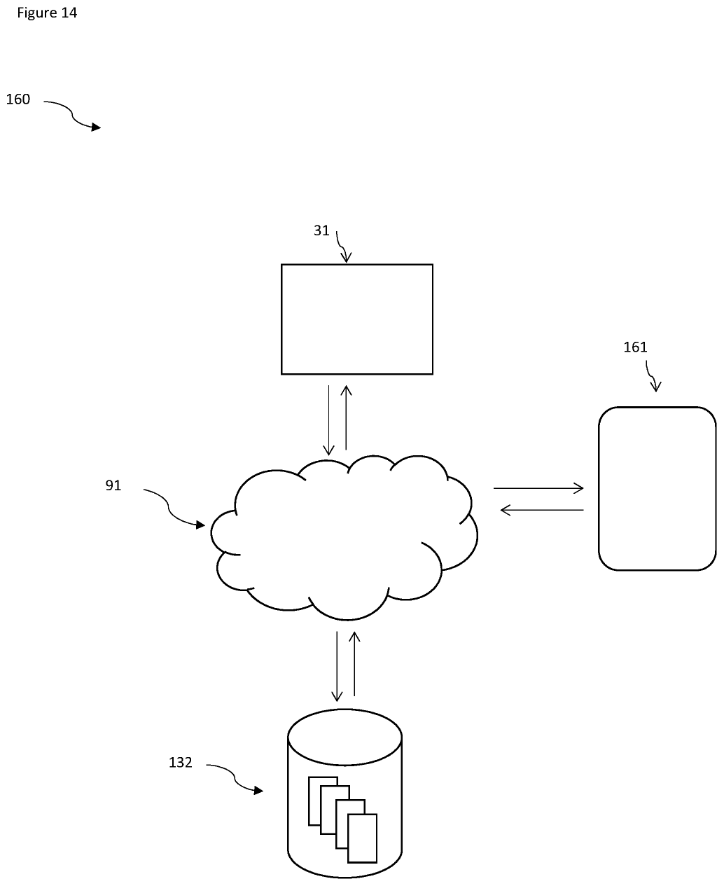

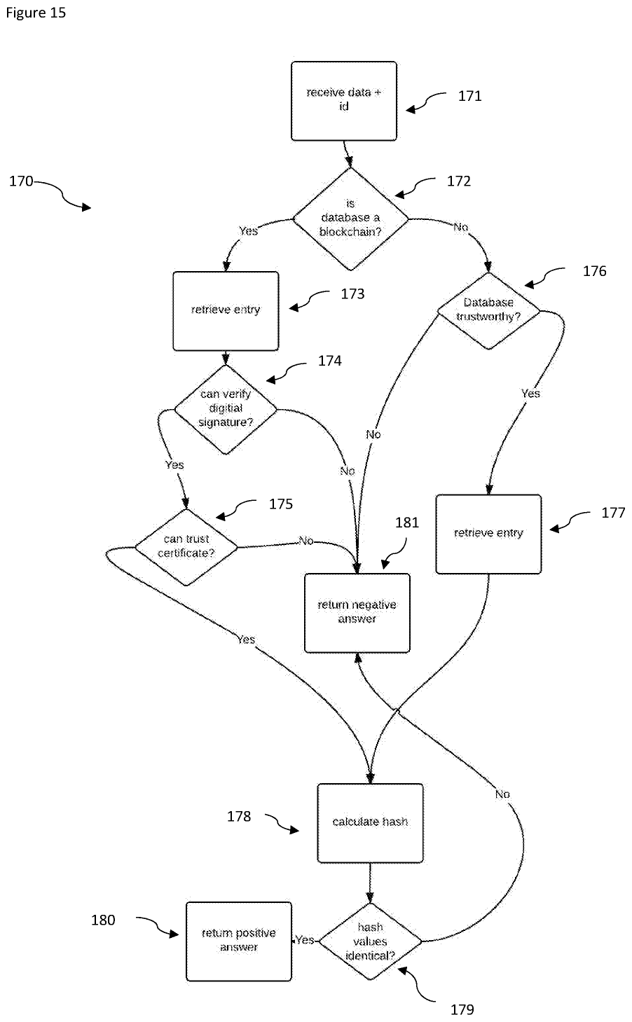

FIG. 14 illustrates an embodiment of a system for creating verifiable data 160 which includes a capture device 31, a server device 132, and an independent third-party device 161. All of the devices 31, 132, 161 are connected to a communications network 91. The third-party device 161 is not a capture device and is not a server device, but it may still carry out the verification process for purported primary data. In FIG. 15 a process 170 is illustrated which may be carried out by such an independent third-party device. At step 171 purported primary data is received by the third-party device 161. Additionally a unique ID may be provided, although in some embodiments the unique ID may instead be derived by calculating a hash of the purported primary data at this early stage. Where a unique ID is provided though, it may include information as to which server device/database has been used to store data about this particular primary data, in a case where multiple databases, possibly run by different organisations, are available on the same network. At step 172 it is determined whether the relevant database is a blockchain. A blockchain provides a good safeguard against data being tampered with, without the need to trust any particular system operator or to know that any particular system is secure from tampering. If the database is not a blockchain then the database must be determined to be trustworthy at step 176. A database may be determined to be trustworthy if it is operated by a known organisation which is known to put safeguards in place to prevent unauthorised access and tampering. Similar safeguards and audit arrangements might be put in place to determine trustworthy database operators as currently apply to authorities which issue SSL certificates for use on the internet.

If the database is determined to be trustworthy either because it is known to be trusted or because it is a blockchain which has intrinsic safeguards to prevent tampering, then the relevant record will be retrieved (steps 173, 177). In the case of a blockchain a further check is made to verify the digital signature on the record at steps 174 and 175. If for any reason the database or the record cannot be trusted then a negative answer is returned at step 181.

Otherwise, a hash of the purported primary data is calculated, if not done so already to facilitate the retrieval steps, at step 178. The calculated hash is then compared to the hash retrieved from the database at step 179, and if the calculated and retrieved hash values are identical then a positive answer is returned, indicating that the purported data is in fact unaltered primary data from a capture device. At the same time, metadata or a hash of metadata may be retrieved from the database and either compared with purported metadata or just presented as authoritative metadata relating to that verified primary data.

Data stored according to the invention can be verified at a later date as genuine, unaltered primary data which has come directly from a physical sensor (e.g. a camera). It can also be reliably associated with metadata, for example the place and time when the photograph or other recording was taken. The evidential value of the primary data is therefore significantly increased.

The embodiments described are by way of example only, and it will be understood that various modifications may be made within the scope of the invention. The invention is defined in the appended claims.

1. A system for creating verifiable data, the system comprising:
a capture device, the capture device including at least one sensor for capturing primary data, and being adapted to provide at least one item of metadata relating to the captured primary data, and the capture device further including a processor;
a server device, the server device including data storage;
a data transmission channel being provided for allowing data transfer between the capture device and the server device,
the capture device being provided with a computer program which when executed on the processor causes the capture device to carry out the steps of:
acquiring primary data from the sensor and storing the primary data;
calculating a cryptographic transformation of the primary data;
optionally calculating a cryptographic transformation of the at least one item of metadata;
transmitting the cryptographic transformation of the primary data, together with at least one of the at least one item of metadata and the cryptographic transformation of the at least one item of metadata,
and the server device being adapted to receive and store the cryptographic transformation of the primary data, together with at least one of the at least one item of metadata and the cryptographic transformation of the at least one item of metadata.

2. A system as claimed in claim 1, in which the at least one sensor includes at least one of a camera and a microphone.

3. (canceled)

4. A system as claimed in claim 1, in which the cryptographic transformation includes at least one of the use of a secret key, a MAC (message authentication code) and a digital signature.

5. (canceled)

6. (canceled)

7. A system as claimed in claim 1, wherein the cryptographic transformation includes use of a secret key in which the secret key is at least one of obfuscated in the compiled program code of the computer program on the capture device and a cryptographic digest of the compiled program code of the computer program.

8. (canceled)

9. A system as claimed in claim 1, in which the cryptographic transformation of the primary data is calculated in a single function taking as input the whole of the primary data.

10. A system as claimed in claim 1, in which the cryptographic transformation of the primary data is calculated by splitting the primary data into blocks, individually applying a cryptographic transformation to each block, and then combining the cryptographic transformations of the blocks.

11. A system as claimed in claim 10, in which the cryptographic transformations of the blocks are combined by calculating a single cryptographic transformation over all of the individual cryptographic transformations of blocks.

12. A system as claimed in claim 1, in which the at least one item of metadata includes at least one of an identifier for the capture device, a timestamp and the geographical position of the device when the capture was made and in which at least one item of metadata is acquired from a hardware component of the capture device.

13. (canceled)

14. (canceled)

15. (canceled)

16. A system as claimed in claim 1, in which a cryptographic transformation of the at least one item of metadata is calculated on the capture device, and in which the cryptographic transformation of the at least one item of metadata is transmitted to the server device.

17. A system as claimed in claim 1, in which a cryptographic transformation of a combination of the primary data and the at least one item of metadata is calculated on the capture device and transmitted to the server device.

18. A system as claimed in claim 1, in which the server device performs a check on the integrity of the capture device before storing data.

19. A system as claimed in claim 18, in which the integrity check includes at least one of a local check performed by the computer program running on the capture device, the results of which are reported to the server device and a third-party attestation.

20. (canceled)

21. A system as claimed in claim 1, in which the program on the capture device is arranged to have exclusive access to an area of storage on the capture device wherein the exclusive area of storage is used for storing calculated cryptographic transformations temporarily prior to transmission to the server device.

22. (canceled)

23. A system as claimed in claim 1, wherein the server device is provided by a distributed network of computers in which the distributed network of computers stores data in a sequential distributed database in the form of a blockchain.

24. (canceled)

25. A method for verifying data stored by the system of claim 1, the method including the steps of:
accepting purported primary data for verification;
calculating a cryptographic transformation of the purported primary data;
retrieving a stored cryptographic transformation from storage on the server device of the system;
comparing the calculated transformation to the retrieved transformation;
if the calculated and retrieved transformations are identical, returning a positive result indicating that the purported primary data is verified, otherwise returning a negative result indicating that the purported primary data is not verified.

26. A method as claimed in claim 25, in which a key is used to decrypt the stored cryptographic transformation before the comparison is made.

27. A method as claimed in claim 25 wherein the method is executed on the capture device, on the server device or on a device other than the capture device and the server device.

28. (canceled)

29. (canceled)

30. A system for creating verifiable data, the system comprising:
a capture device, the capture device including at least one sensor for capturing primary data, and being adapted to provide at least one item of metadata relating to the captured primary data, and the capture device further including a processor;
a server device, the server device including data storage; and
a data transmission channel being provided for allowing data transfer between the capture device and the server device,
the capture device being provided with a computer program which when executed on the processor causes the capture device to carry out the steps of:
communicating with the server device to establish a device key on the capture device which is trusted by the server device;
acquiring primary data from the sensor and storing the primary data;
calculating a MAC or digital signature of a combination of the primary data and the metadata, using the device key;
embedding the MAC or digital signature of the combination of the primary data and the metadata into the primary data, and storing the primary data with embedded MAC or digital signature.

31. (canceled)

32. (canceled)

33. A system as claimed in claim 30, in which the MAC or digital signature is calculated in a single function taking the as input the whole of the primary data.

34. A system as claimed in claim 30, in which the MAC or digital signature of the primary data is calculated by splitting the primary data into blocks, individually applying a cryptographic transformation to each block, and then calculating a MAC or digital signature of a combination of the cryptographic transformations of the blocks.

35.-42. (canceled)
